(19) United States
(12) Patent Application Publication
(10) Pub. No.: US 2012/0142401 A1
(43) Pub. Date: Jun. 7, 2012

(54) PORTABLE TERMINAL DEVICE

(75) Inventors: Jun Takahashi, Miyagi (JP); Akinori Oohira, Kanagawa (JP); Takeshi Nagane, Miyagi (JP); Yasuyuki Tanaka, Kanagawa (JP); Hiroyuki Ogihara, Tokyo (JP)

(73) Assignee: PANASONIC CORPORATION, Osaka (JP)

(21) Appl. No.: 13/389,409

(22) PCT Filed: Oct. 19, 2010
(86) PCT No.: PCT/JP2010/006196

§ 371 Date: Feb. 7, 2012

(30) Foreign Application Priority Data
Oct. 21, 2009 (JP) 209-242452

(51) Int. Cl. H04W 88/02

(52) U.S. Cl. 455/566

(57) ABSTRACT

Disclosed is a portable terminal device, which has a reduced thickness, while ensuring a strength with which a display unit can be excellently held. In the device (100), the flat-board-like display unit (200) provided with a display drive section (213) that drives a liquid crystal display section (211) is attached to a first case (110) with a metal rear plate (160) therebetween. The rear plate (160) is provided with a reinforcing section (180), which is formed by folding back one plate end portion, which has a predetermined width, a plurality of times into a roll-shape on the rear surface side of the rear plate (160). The reinforcing section (180) is disposed at a position that includes the horizontal projection area of the display drive section (213), and prevents stress from concentrating on the display drive section (213) by reinforcing the display drive section (213).

### TECHNICAL FIELD

The present invention relates to a portable terminal apparatus such as a mobile telephone having a display section.

### BACKGROUND ART

Conventionally, a flat display unit such as a liquid crystal display (LCD) including a liquid crystal panel and a backlight has been widely used as a display section of a radio portable terminal apparatus (hereinafter just referred to as a portable terminal apparatus) such as a mobile telephone.

For example, the LCD is arranged to face a backlight module radiating light to the liquid crystal display module, on the rear surface of the liquid crystal display module that includes a glass substrate sandwiching a plurality of liquid crystal cells, and a liquid crystal drive IC configured at a stretching portion corresponding to the end of the glass substrate.

A flat display unit such as LCD is configured as mentioned above and is mounted on a mobile telephone, for example, so as to be placed on a flat portion provided for a casing of the mobile telephone.

Generally, the flat display unit mounted for a mobile telephone configures a display section by arranging in a casing on the surface mounted with a speaker that sounds out speech of an intended party, so that a shock might be applied near the display section such as when a user presses the user's ear against the mobile telephone while in use.

The shock might concentrate a stress on the liquid crystal drive IC configured on the glass substrate of the flat display unit that configures the display section. Therefore, for example, Patent Literature 1 arranges the glass substrate on a metal frame, and the frame is processed to form a bridge at a position corresponding to the stretching portion of the liquid crystal drive IC or the glass substrate in order to increase the strength of the LCD itself.

### Citation List

### Patent Literature

### PTL 1

Japanese Patent Application Laid-Open No. 2009-9820

### SUMMARY OF INVENTION

### Technical Problem

Recently, there is a demand that portable terminals such as mobile telephones equipped with liquid crystal display units to be thinner as well as less power consuming and lighter.

According to a conventional configuration as described in Patent Literature 1, a bridge portion is formed on the frame by bending its metal base portion arranged at the rear surface of a stretching portion of the glass substrate, in the cross section of the U shape toward the mounting surface. That is, a bridge portion has configuration where a flat plate section bridged on upper ends of a portion raised from the bottom of the bridge portion decreases the stress concentration by supporting the stretching portion of the glass substrate at higher place than the bottom surface, so that the liquid crystal display unit itself thickens by a height of the raised portion. A recessed portion is formed on the raised portion described in Patent Literature 1 and reinforces the raised portion. Therefore, the raised portion needs to have a predetermined length to ensure an area for forming the recessed portion, so that this makes the liquid crystal display unit difficult to be much thinner.

It is therefore an object of the present invention to provide a portable terminal apparatus that can be thinner while ensuring a strength enough to satisfactorily hold a display unit.

### Solution to Problem

One aspect of the portable terminal apparatus of the present invention includes: a display unit having a display section, the display unit being flat; a rear plate where the display unit is mounted on a surface, the rear plate being metal; and a casing to which the rear plate is attached, where the rear plate employs a configuration to include a reinforcing section that is formed by repeatedly folding one end with a specified width on a rear surface side of the rear plate and allows a repeatedly folded portion to be layered on the rear surface side of the rear plate.

### Advantageous Effects of Invention

The present invention can provide a portable terminal apparatus that can be thinner while ensuring a strength enough to satisfactorily hold a display unit.

### BRIEF DESCRIPTION OF DRAWINGS

FIG. 1 is a perspective view showing a portable terminal apparatus according to an embodiment of the present invention;

FIG. 2 is an exploded perspective view showing a first casing including a display section in the portable terminal apparatus shown in FIG. 1;

FIG. 3 is an A-A line cross-sectional view of the portable terminal apparatus shown in FIG. 1;

FIG. 4 is a schematic diagram showing a reinforcing section of the portable terminal apparatus according to the present embodiment;

FIG. 5 is a schematic diagram showing a strength against deflection; and

FIG. 6 is a schematic diagram showing a modification example of the reinforcing section in the portable terminal apparatus according to the present embodiment.

### DESCRIPTION OF EMBODIMENTS

Now, an embodiment of the present invention will be described in detail with reference to the accompanying drawings.

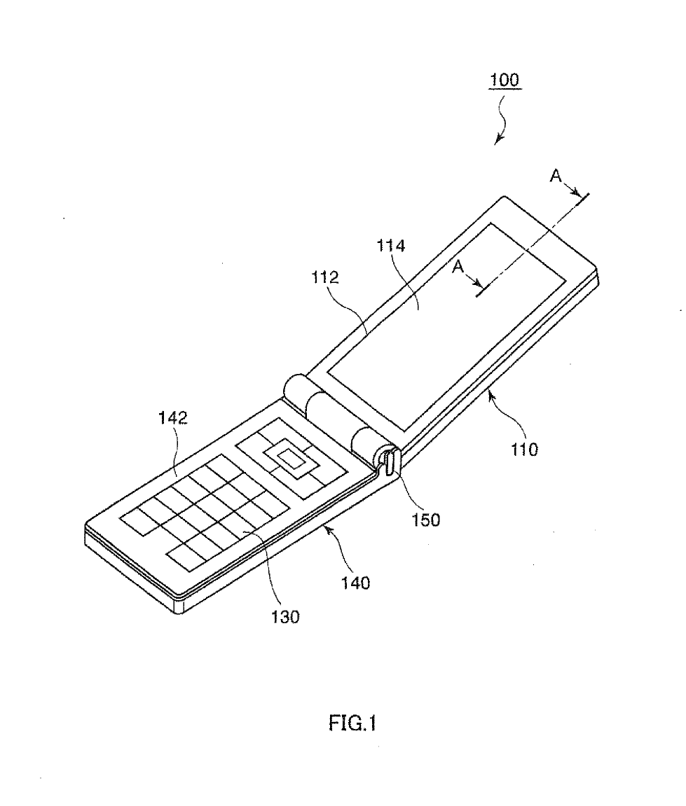

FIG. 1 is a perspective view showing portable terminal apparatus 100 according to an embodiment of the present invention. The present embodiment describes portable terminal apparatus 100 as a mobile telephone, but the invention is not limited thereto and is also applicable to any electronic apparatuses as portable terminal apparatuses having display sections.

Portable terminal apparatus 100 shown in FIG. 1 is a flip mobile telephone. In portable terminal apparatus 100, second casing 140 having operation section 130 is rotatably coupled to first casing 110 having display surface 112 through connection section 150. Portable terminal apparatus 100 may also represent a slide or straight model mobile telephone equipped with the display section.

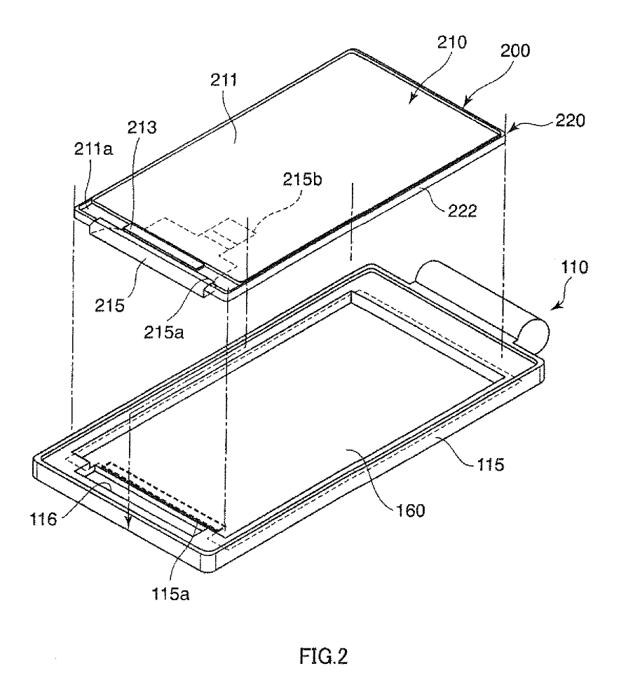

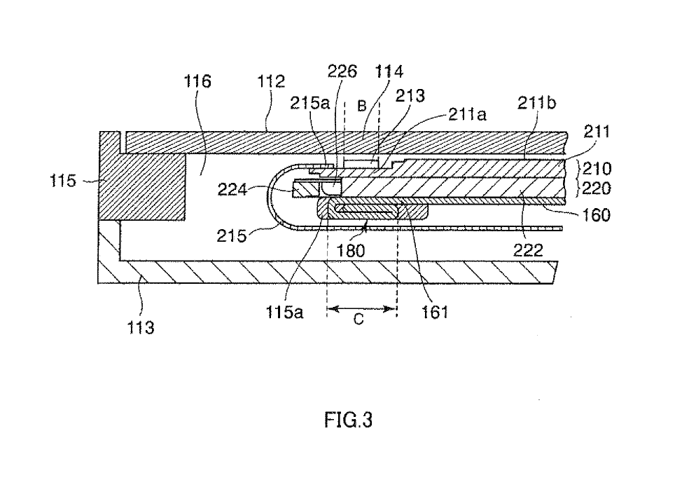

In second casing 140, operation section 130 is arranged on surface 142 where folded first casing 110 is placed. On the other hand, in first casing 110, display unit 200 (see FIGS. 2 and 3) is arranged on a surface (equivalent to display surface 112) opposite to surface 142 of second casing 140 when the portable terminal apparatus is folded, display unit 200 displaying data through transparent display panel 114 that configures display surface 112. Surface 142 of second casing 140 is arranged with a microphone that collects speech from a user, and display surface 112 of first casing 110 is arranged with a speaker (not shown) that sounds out speech from an intended party.

FIG. 2 is an exploded perspective view showing the first casing including the display section in the portable terminal apparatus shown in FIG. 1, and FIG. 3 is an A-A cross-sectional view of the portable terminal apparatus shown in FIG. 1.

As shown in FIG. 2, on first easing 110 of portable terminal apparatus 100 (see FIG. 2), metal rear plate 160 is attached to casing frame section 115 that is formed into a rectangular frame shape, and display unit 200 having display section 211 is mounted on this rear plate 160. In first casing 110, casing frame section 115 is attached to an opening side of box-shaped casing body 113.

Although display unit 200 is shaped into a flat plate and is described here as a liquid crystal display unit including display section 211 using a liquid crystal module, this is not limited thereto and it is possible to be an organic EL display unit including a display section that uses an EL element.

Display unit 200 includes display module 210 that includes display section (hereinafter referred to as a “liquid crystal display section”) 211 including a plurality of liquid crystal cells sandwiched between glasses, and display drive section (or herein referred to as liquid crystal display drive section (liquid crystal display drive 1C)) 213 formed at stretching end 211a, that is, a stretching end (a stretching part from an effective display area) of a glass at the bottom side of liquid crystal display section 211. Display module 210 configures a planar surface where one of surfaces of liquid crystal display section 211 is assumed as display surface 211b. Display unit 200 includes this display module 210 and backlight module 220 that is attached to a rear surface of liquid crystal display section 211 in display module 210 and radiates light to liquid crystal display section 211.

Here, liquid crystal display section 211 is shaped into a rectangular plate and radiated light of surface emitting from backlight module 220 that is arranged on a surface (rear surface) opposite to display surface 211b.

As shown in FIG. 3, backlight module 220 includes a surface-emitting section including rectangular light guide plate 222 arranged at the rear surface of liquid crystal display section 211 so as to cover the effective display area of liquid crystal display section 211, and backlight frame section 224 holding liquid crystal display section 211 together with the surface-emitting section.

Here, light guide plate 222 in the surface-emitting section is attached all over the rear surface of liquid crystal display section 211 and emits from the surface by the light radiated inside from light emitting element 226 such as an LED arranged at the side end of light guide plate 222 which surface is emitting. In light guide plate 222, it is also possible to layer in order, for example, a diffusion sheet, a prism sheet (light-collection sheet), and a rim sheet, all over the plane (surface) facing liquid crystal display section 211. The diffusion sheet transmits and diffuses incident light and the prism sheet outputs incident light so that the traveling direction of the incident light is adjusted to be orthogonal to the light-emitting face. The rim sheet is a light-blocking double-sided adhesive tape and is formed such that outgoing light from light guide plate 222 is radiated to the effective display area (area to display images) of liquid crystal display section 211, Bonds backlight module 220 including light guide plate 222 is integrally pasted to liquid crystal display section 211 through the rim sheet.

In display unit 200, display drive section (herein, referred to as “liquid crystal display drive section”) 213 formed at stretching end 211a of liquid crystal display section 211 connects with end 215a of FPC (Flexible Printed Circuit) 215 that is connected to a main substrate (not shown). One end 215a of FPC 215 electrically connects with such as light emitting element 226 as well as display drive section 213 that drives liquid crystal display section 211.

FPC 215 extends from the edge portion of the end on the surface to the rear surface at the one end (stretching end 211a) of display unit 200 and is bent so as to cover the one end, passes through FPC through-hole (insertion hole) 116 formed in casing frame section 115, and is guided into first casing 110 (casing body 113 in more detail). In this manner, FPC 215 is connected to the main substrate (not shown) arranged in first casing 110.

Rear plate 160 is attached to a frame shape part of casing frame section 115 from the rear surface side and one end part of rear plate 160 is arranged along one side of FPC through-hole 116 in casing frame section 115.

FPC through-hole 116 is formed in casing frame section 115 along one end part at the front end, when the end connected to the second casing through the connection section is assumed to be a base end. Edge portion 115a at the base end restricted by FPC through-hole 116 is reinforced by reinforcing section 180 formed by repeatedly folding end part (one end) 161 of rear plate 160. Reinforcing section 180 is formed such that a part of rear plate 160 overlaps with each other in the direction of plate thickness on the rear surface side of rear plate 160.

To form reinforcing section 180, the one end of rectangular rear plate 160 is repeatedly folded so as to be rolled on the side opposite to display unit 200, the one end having the same length as a longer side of FPC through-hole 116.

Reinforcing section 180 extends in a shorter direction of first casing 110 and is formed into a long and narrow flat plate having a predetermined thickness at the folded portion that forms a layer.

Reinforcing section 180 is positioned at a reversely projected portion corresponding to display drive section 213 of display unit 200 mounted on rear plate 160, that is, the position including a horizontal projection area. Reinforcing section 180 is formed on rear plate 160 at an opening edge of FPC through-hole 116 so as to cross the center of FPC through-hole 116 in a width direction (the center of lengthwise direction).

As shown in FIG. 3, reinforcing section 180 is disposed near FPC through-hole 116 (edge portion 115a as the longer opening edge of FPC through-hole 116) so as to overlap with disposition area B for display drive section 213. Disposition area C for reinforcing section 180 covers disposition area B for display drive section 213. Reinforcing section 180 is formed by repeatedly folding the end of rear plate 160 so that a plurality of plate-like portions (folded portions) overlap with each other for a predetermined length while so as to keep disposition area B for display drive section 213 smaller than disposition area C for reinforcing section, that is, by layering.

Specifically, reinforcing section 180 is formed by folding one end of rear plate 160 toward the face opposite to the other face where display unit 200 is mounted on rear plate 160, and folding again so as to be longer than the width of display drive section 213 (the length of disposition area B for display drive section 213).

The second folded portion is placed between the first folded portion and rear plate 160 so as to form a rolled shape.

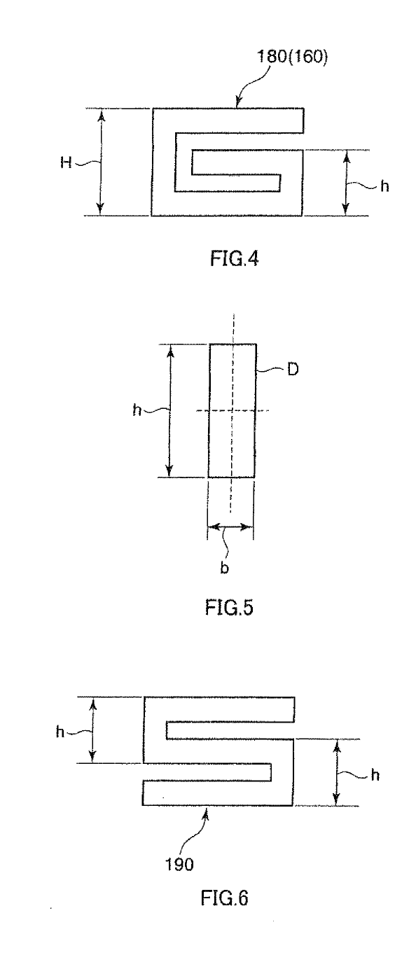

FIG. 4 is a schematic diagram showing a reinforcing section of the portable terminal apparatus according to the embodiment of the present invention.

As shown in FIG. 4, reinforcing section 180 ensures bend heights H and h by repeatedly folding rear plate 160. As shown in FIG. 5, this is because, according to the equation for a cross-section second moment of area I=bh³/12 applicable to rectangular-shape cross section D having width b and height h, ensuring bend heights H and h can provide the effect of the cube rather than increasing the plate thickness (equivalent to b), so that it is possible to increase the strength effectively.

Although reinforcing section 180 is explained to have a configuration formed by folding a part of rear plate 160 into a rolled shape, this is not limited thereto.

On rear plate 160 (see FIG. 3) of first casing 110 (see FIG. 3) for portable terminal apparatus 100, reinforcing section 190 (see FIG. 6) may be formed by repeatedly folding (zigzag-folding) a part of rear plate 160 on the place where the reinforcing section is formed, so that three or more folded portions are layered in a direction of overlapping two sides of each folded portion.

Reinforcing section 190 shown in FIG. 6 can ensure bend heights h at both ends of the folded and overlapping portion, and by this means increase the strength of reinforcing section 190 itself.

In this manner, reinforcing sections 180 and 190 reinforce the vicinity of through-hole 116 in casing frame section 115 and reinforces the whole of display drive section 213.

According to a conventional configuration, the FPC through-hole to pass through FPC is formed in the first casing, corresponding to the stretching portion of the extending FPC on the glass substrate mounted with the liquid crystal drive IC in the display unit, so that it is difficult to ensure the strength.

In portable terminal apparatus 100 according to the present embodiment, however, reinforcing sections 180 and 190 are formed near FPC through-hole 116 along the lengthwise direction (width direction) of FPC through-hole 116. Reinforcing sections 180 and 190 are formed on rear plate 160 at an opening edge of FPC through-hole 116 so as to cross the center of FPC through-hole 116 in the width direction (the center of lengthwise direction). This enables to ensure the strength at the opening edge of FPC through-hole 116.

Reinforcing sections 180 and 190 are formed at the position overlapping with display drive section (display drive IC) 213 of mounted display unit 200 in the area covering the horizontal projection area for the display drive IC, so that it is possible to decrease deflection of display drive section (display drive IC) 213 and reduce stress concentration. In addition, reinforcing sections 180 and 190 are formed as an elongated plate-like body having the bend height for the repeatedly folded portion, just by repeatedly folding a part of rear plate 160 where display unit 200 is mounted, toward the face opposite to the other face where display unit 200 is mounted. Therefore, there is no need to ensure a raised height in such a casing that the rear plate is raised to configure the reinforcing section, so that it is possible to easily improve the strength.

By this means, even if a shock may be applied to display unit 200 through display panel 114 when a user presses the user's ear against display surface 112 of first casing 110 while using portable terminal apparatus 100, the portable terminal apparatus decreases the amount of casing deformation (deflection) applied to display drive section 213 and stretching end 211a and alleviates stress concentration. Accordingly, it is possible to make a portable terminal apparatus thinner, while ensuring the strength enough to satisfactorily hold display unit 200.

Although the present embodiment has explained that the liquid crystal display unit configures the display section supported by the rear plate, an organic EL (Electro-Luminescence) display unit may be used. In this case, reinforcing sections 180 and 190 reinforce an organic EL display drive IC so as to cover the horizontal projection area in the disposition area for the organic EL display drive IC, in the same manner as reinforcing the liquid crystal display drive section (liquid crystal display drive IC) as display drive section 213. When using the organic EL display unit instead of the liquid crystal display unit, there is no need to use a backlight module, so that it is possible to make a portable terminal apparatus thinner moreover.

The disclosure of Japanese Patent Application No. 2009-242452, filed on Oct. 21, 2009 including the specification, drawings and abstract, is incorporated herein by reference in its entirety.

### INDUSTRIAL APPLICABILITY

The portable terminal apparatus according to the present invention ensures a strength enough to satisfactorily hold a display unit, provides an effect of being made thinner, and is useful as a mobile telephones.

### REFERENCE SIGNS LIST

100 Portable terminal apparatus
110 First casing
112 Display surface
113 Casing body
115 Casing frame section

### 116 Through-hole

140 Second casing
160 Rear plate

### 161 One end

180, 190 Reinforcing section
200 Display unit
211 Liquid crystal display section
213 Display drive section

1. A portable terminal apparatus comprising:
a display unit having a display section, the display unit being flat;
a rear plate where the display unit is mounted on a surface, the rear plate being metal; and
a casing to which the rear plate is attached,
wherein the rear plate includes a reinforcing section that is formed by repeatedly folding one end with a predetermined width on a rear surface side of the rear plate and allows a repeatedly folded portion to be layered on the rear surface side of the rear plate.

2. The portable terminal apparatus according to claim 1, wherein the reinforcing section is formed by repeatedly folding one end of the rear plate into a rolled shape.

3. The portable terminal apparatus according to claim 1, wherein:
the rear plate includes a rectangular insertion hole to insert a flexible substrate guided from the display unit; and
the reinforcing section is provided along one side extending in a lengthwise direction of the insertion hole and is located at an edge portion regulating the one side.

4. The portable terminal apparatus according to claim 3, wherein the reinforcing section is provided so as to cross a center of the insertion hole in the lengthwise direction.

5. The portable terminal apparatus according to claim 3, wherein the reinforcing section has virtually the same length as the one side of the insertion hole.

6. The portable terminal apparatus according to claim 1, wherein:
the display unit includes a display drive section that drives the display section; and
the reinforcing section is formed at a position including a horizontal projection area of the display drive section on the rear plate.

7. The portable terminal apparatus according to claim 1, wherein, in the reinforcing section, the repeatedly folded portion is layered toward the rear surface, by zigzag-folding the one end of the rear plate.
